(19) United States
(12) Patent Application Publication
(10) Pub. No.: US 2008/0143105 A1
(43) Pub. Date: Jun. 19, 2008

(54) FLUID COUPLING

(75) Inventors: Timothy F. Carey, Weirton, WV (US); Christopher E. Schadewald, Whitehouse, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Eaton Corporation, Cleveland, OH (US)

(21) Appl. No.: 11/859,966

(22) Filed: Sep. 24, 2007

Related U.S. Application Data
(60) Provisional application No. 60/826,694, filed on Sep. 22, 2006.

(51) Int. Cl. F16L 33/00

(52) U.S. Cl. 285/239

(57) ABSTRACT

In one embodiment, a high-pressure hose nipple includes a nipple body adapted on a first end for mating assembly with and providing a path of fluid communication to external piping, the nipple body adapted on a second end for selective assembly with and providing a path of fluid communication to other external piping, where a channel through the body provides a path of fluid communication between the first end and the second end, and a cylindrical bore disposed within the body at the second end where a diameter of the cylindrical bore exceeds an outside diameter of the external piping so that the external piping may cooperate with the hose nipple in a linear amount exceeding the outside diameter of the external piping.

### BACKGROUND

1. Field of the Invention

The present application relates to a fluid coupling assembly and, more particularly, to a fluid coupling assembly that permits length and angular adjustment.

2. Description of the Related Art

In fluid power controlled and actuated machines, the locations of some components are controlled by the structure of the machine and usually cannot be altered. Other components, however, may be placed where they are relatively easy to connect, readily accessible and convenient to service.

System engineers may strive to eliminate as many fluid connectors as possible by using manifolds to interconnect components. However, in many cases, external piping—either rigid conduit or flexible high pressure reinforced hydraulic hose—provide desirable features. Engineers incorporate the such features while attempting to minimize potential leakage and maximize serviceability.

Once the design issues are resolved, practical installation issues often arise. In some cases, fitting designs are rigid and lack adjustability at the point of assembly to accommodate any component misalignment or length issues. Due to this lack of adjustability, certain fittings or combination of fittings are avoided by designers because of inherent tolerance and stack-up issues. For example, double elbow hose assemblies are often avoided because they require a fixed angle between the two end fittings. In cases where a double elbow hose assembly is forced to fit the application even though it is not adjustable, the hose life may be significantly reduced due to induced torsion on the hose. In other applications, flexible hose is undesirably compressed, stretched, or twisted to mate with rigid components. Additionally, selecting correct hose length may be complicated by the fact that some flexible hoses shorten when under pressure.

### BRIEF DESCRIPTION OF THE DRAWINGS

It will be appreciated that the illustrated boundaries of elements (e.g., boxes or groups of boxes) in the figures represent one example of the boundaries. One of ordinary skill in the art will appreciate that one element may be designed as multiple elements or that multiple elements may be designed as one element. An element shown as an internal component of another element may be implemented as an external component and vice versa.

Further, in the accompanying drawings and description that follow, like parts are indicated throughout the drawings and description with the same reference numerals, respectively. The figures may not be drawn to scale and the proportions of certain parts may be exaggerated for convenience of illustration.

FIG. 1 illustrates an exemplary coupling nipple.

FIG. 2 illustrates an exemplary cross-sectional view of one embodiment of a coupling nipple.

FIG. 3 illustrates an exploded view of one embodiment of a coupling nipple and a resilient hose.

FIG. 4 illustrates an exploded view of one embodiment of a coupling nipple and a tube.

FIG. 5 illustrates a cross-sectional view of a coupling nipple combined with a tube.

FIG. 6 illustrates an exploded view of an embodiment of a coupling nipple and a tube.

### DETAILED DESCRIPTION

Certain terminology will be used in the foregoing description for convenience in reference only and will not be limiting. The terms “forward” and “rearward” with respect to each component of the coupling assembly will refer to direction towards and away from, respectively, the coupling direction. The terms “rightward” and “leftward” will refer to directions in the drawings in connection with which the terminology is used. The terms “inwardly” and “outwardly” will refer to directions toward and away from, respectively, the geometric centerline of the coupling assembly. The terms “upward” and “downward” will refer to directions as taken in the drawings in connection with which the terminology is used. All foregoing terms mentioned above include the normal derivative and equivalents thereof.

The present application is directed to a coupling and assembly that permits small adjustments to be made when connecting high pressure fluid components. Exemplary adjustments include lengthwise adjustment and rotational adjustment (i.e., the phase angle) between two components.

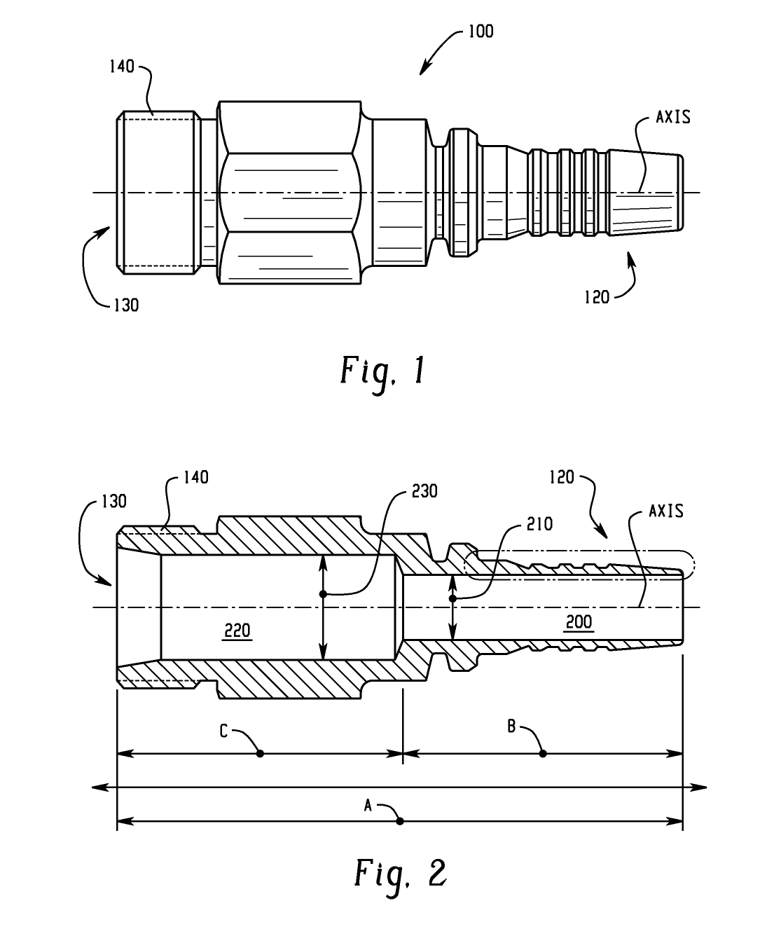

FIG. 1 illustrates a coupling nipple 100 useful, for example in high fluid pressure environments such as those encountered in pressurized hydraulic machinery. In certain situations, it may be desirable to connect a flexible hydraulic hose to rigid conduit. A coupling 100 may find utility in such situations where one end of the flexible hydraulic hose is urged over a bayonet portion 120 of the coupling nipple 100 while an opposing side 130 may be configured to accept the rigid conduit. Once the conduit is seated within the coupling, a threaded compression type nut may draw the assembly together. In the illustrated embodiment, threads 140 may be standard “right hand” male threads configured to mate with SAE standard configurations such as female JIC or O-ring type connections, although other connections may be substituted to achieve desired functionality or performance.

While the illustration shows different ends such as bayonet portion 120 and opposing side 130 configured to accept the rigid conduit, those skilled will appreciate that alternative couplings may include the same or similar ends such as two bayonet ends or two conduit ends.

In one embodiment, the coupling nipple 100 can be formed of stainless steel. In alternative embodiments, it can be formed of other materials, such as brass, aluminum, carbon, steel, and plastic.

Referring now to FIG. 2, a cross sectional view of an exemplary coupling having an overall length “A” shows a fluid path 200 along a central axis on the bayonet portion 120 of the coupling. The fluid path 200 in the exemplary embodiment may be a machined bore having a diameter 210 roughly coinciding with an interior diameter of a determined flexible hose (not shown). The bayonet portion 120 may also define a length “B” and external striations selected to ensure the hydraulic hose will be sufficiently mated and/or that an area may be provided for clamping or other means of affixing flexible hose in a non-leaking manner to the coupling.

On an opposing side, coupling may include a fluid path 220 along the central axis of a female portion of the coupling. The fluid path in the exemplary embodiment may be a machined bore having a diameter 230 that roughly coincides with the outer diameter of the male end of the rigid pipe or conduit to be mated. The fluid path 220 may also define a length “C” selected to ensure sufficient fluid flow through the coupling when in use. As seen, the combined lengths of the fluid paths “B” and “C” roughly equal the overall length “A” of the coupling. In other words, each fluid path B and C may be roughly equal to half the overall length A. In other embodiments, the lengths of fluid paths “B” and “C” roughly equal and related to the size of external piping on which the coupling is intended for use.

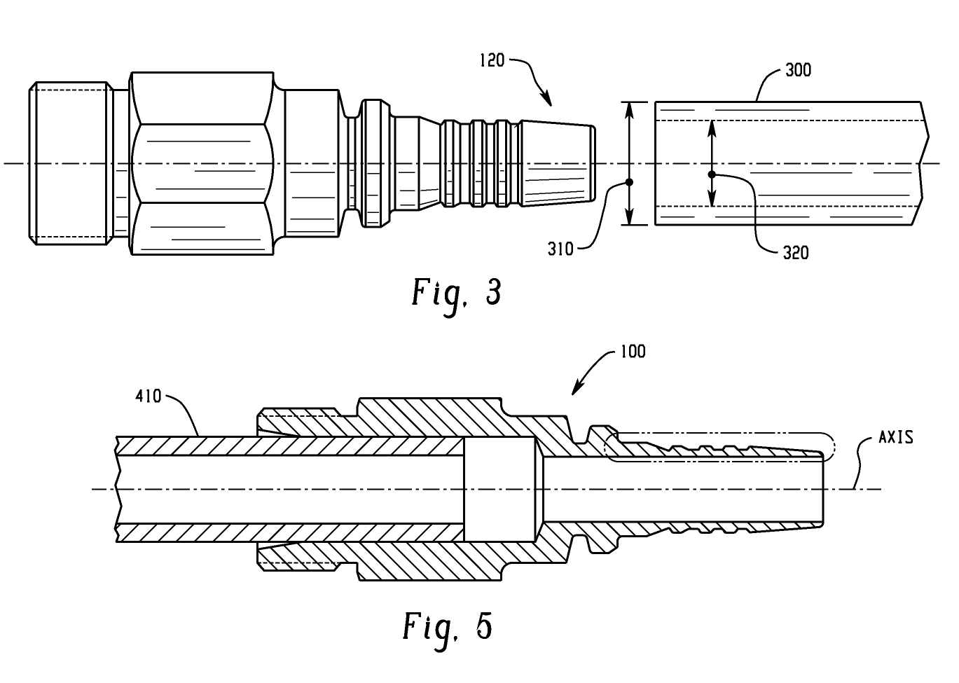

With reference now to FIG. 3, a flexible hose 300 may include an outer diameter 310 and an inner diameter 320. The inner diameter may be selected to snugly fit over the coupling bayonet portion 120. In certain conditions, the flexible hose 300 may be clamped, or otherwise affixed upon the bayonet portion 120 such that, under expected conditions, the flexible hose 300 will not part from the coupling or leak.

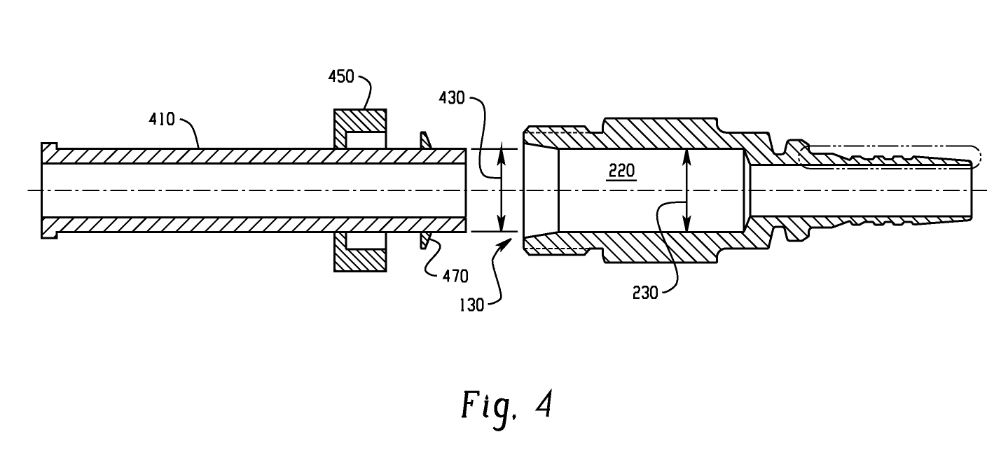

Referring to FIG. 4, an opposing fluid path may also be associated with the coupling for example in the form of rigid conduit 410. The conduit may include an outer diameter 430 slightly smaller than the inner diameter 230 of coupling to minimize fluid leakage. To improve mechanical strength of the coupled system, fluid path 220 may be lengthwise suitable to accommodate lengths of conduit exceeding the outer diameter of conduit 410. In certain instances, the depth “C” of fluid path 220 lies between 1.5 and 3.0 times the outer diameter 430.

In another embodiment, the coupling includes a fluid path configured to receive variable lengths of hose, pipe, tube, and the like, such that overall assembly length may be adjusted by varying the depth of the pipe for example in the fluid path. One exemplary fluid path may provide adjustment in a range of 1.25-3.75 cm.

Continuing reference to FIG. 4 shows a female threaded nut 450 disposed on conduit for eventual threaded engagement with male threads on the coupling. To assist in maintaining a fluid tight system, a seal 470 may be interposed between the conduit and the coupling. The seal may include those commercially available from Walterscheid Rohrverbindungstechnik GmbH and other vendors of high pressure or hydraulic seal mechanisms comprising one or more individual components. The seal may operate such that when nut 450 is threaded to the coupling at a determined torque, the seal 470 blocks or inhibits pressurized fluid from leaking from the path through the coupling.

FIG. 5 shows an exemplary embodiment of a rigid pipe 410 fit inside coupling 100. In this embodiment, the fluid path 220 may be seen as extending over half of the entire coupling body thus providing an amount of “play” in the system to compensate for manufacturing deviations, or flexible tube contractions when under pressure. As seen, the conduit may finally rest at a point along the fluid path that permits the system to be assembled without twisting, stretching or otherwise deforming any system components thus extending system life. When so positioned, a user may torque the conduit side using a nut and seal (not shown).

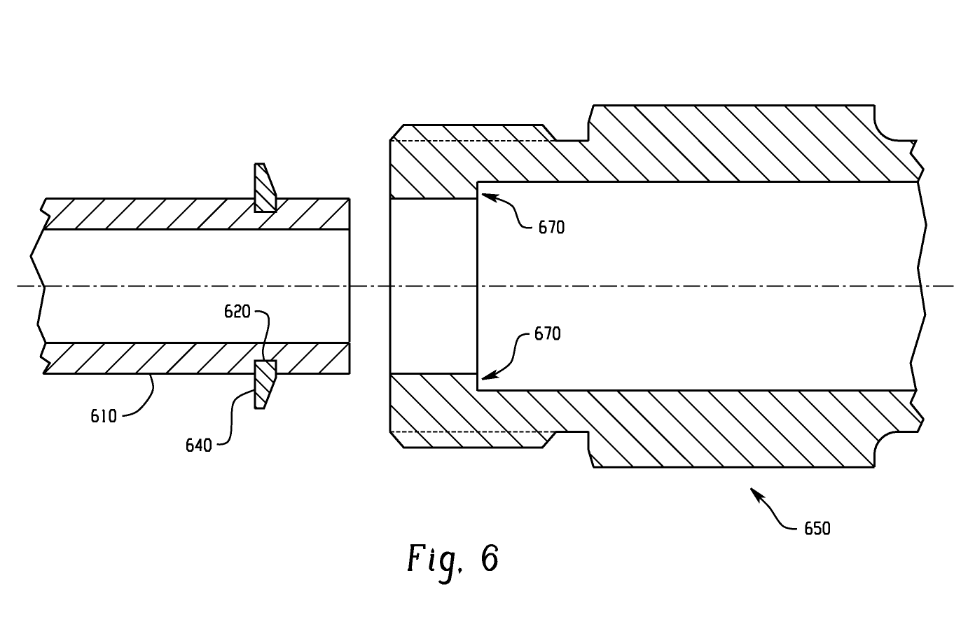

With reference now to FIG. 6, in yet another embodiment a connection tube 610 may include an annular groove 620 around an outside circumference of a male pipe, for example. Disposed within the groove 620 may be a retaining ring 640 configured to mate with a lip 670 included on an inside circumference of a coupling 650. In one embodiment, the ring 640 may be shaped to permit ratcheting in as the pipe is arranged at a proper depth within the coupling. In another embodiment, the ring may permit the assembly from disassembling under pressure. In still another embodiment, a nut and seal assembly as discussed above may also be incorporated into the illustrated retaining ring and channel arrangement shown. In another embodiment, a locking ring assembly as shown in U.S. Pat. No. 5,226,682 may be employed. In yet another embodiment the retaining ring may by disposed within the inner diameter of the coupling and the conduit or external piping insertion end may be fitted with at least one groove, thread or lip to engage the retaining ring.

While the figures illustrate, and the specification describes a flexible hose on one side of the coupling and a rigid conduit on the other side, such description has been used for illustration purposes only. Alternate embodiments may employ any mixture of flexible and rigid components, mid-line, dog-leg, and serially linked coupling assemblies.

There are several potential benefits of the coupling assemblies described above and illustrated in FIGS. 1-6. For example, these adjustable coupling assemblies may permit an end user to adjust the phase angles of the hose assembly to accommodate any misalignment of components when used with hose assemblies, such as double elbow hose assemblies. As another example, these adjustable coupling assemblies permit an end user to adjust the length of the coupling assemblies to compensate for minor deviations and allowing proper fit of components. These potential benefits may be helpful in custom installations and in the aftermarket where hoses may need to be replaced frequently.

In another example, a factory installation such as in an automotive plant or steel mill, locates a hydraulic pump under the assembly line, and a control valve on the assembly line. One method involves crimping one end of a hose, delivering it to the steel mill, then “dry fitting” the hose and fitting and marking how and where to crimp the second hose end. The unfinished hose then is returned to the distributor for final crimping and return to the factory for installation. Another method employs an assembly comprising coupling nipple 100 enabling an entire hose assembly to be crimped once at the distributor to an approximate length, and final adjustments in length and phase may be made in the field.

In another example, hydraulic design engineers may design with only one elbow fitting per hose assembly. This design technique makes hose replacement easier by avoiding the challenges of a replacement hose assembly needing to recreate the exact phase angle of the two elbow fittings. However, designing with only one elbow fitting may cause design difficulties or cause other components to be relocated.

Another method employs coupling nipple 100 enabling double elbow hose assembly designs to be easily installed without the need to exactly replicate phase angles of the original hose assembly. The new fitting can be adjusted during installation to accommodate for the various phase angles can make hydraulic design and maintenance both simpler and more reliable.

Some large diameter hoses are manufactured such that they naturally “set” or bend in one direction. Often the elbow fitting is specified to be attached in a certain direction, either “with” or “against” the natural bend of the hose. This is usually an imprecise technique and often difficult to communicate between the user and the local distributor. Use of the fluid connector and assemblies discussed herein, permits such adjustments to be made in the field.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

While the present application illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's claimed invention. Moreover, the foregoing embodiments are illustrative, and no single feature or element is essential to all possible combinations that may be claimed in this or a later application.

What is claimed is:

1. A high-pressure hose nipple comprising:
a nipple body adapted on a first end for mating assembly with and providing a path of fluid communication to a resilient hose, the nipple body adapted on a second end for selective assembly with and providing a path of fluid communication to a rigid tube, where a channel through the body provides a path of fluid communication between the first end and the second end; and
a cylindrical bore disposed within the body at the second end where a diameter of the cylindrical bore exceeds an outside diameter of the rigid tube so that the rigid tube may be received within the cylindrical bore to a depth exceeding the outside diameter of the rigid tube.

2. The high-pressure hose nipple as set forth in claim 1, further comprising a rigid tube threadably assembled with the second end.

3. The high-pressure hose nipple as set forth in claim 1, further comprising a rigid tube in leak-free assembly with the second end.

4. The high-pressure hose nipple as set forth in claim 1, further comprising at least one seal between an outside surface of the rigid tube and the second end.

5. The high-pressure hose nipple as set forth in claim 2, further comprising a first retainer between the rigid tube and the second end for limiting axial movement of the rigid tube in a direction away from the second end.

6. The high-pressure hose nipple as set forth in claim 1, wherein the depth of the cylindrical bore exceeds the outside diameter of the rigid tube by between 1.5 and 3 times.

7. The high-pressure hose nipple as set forth in claim 1, further comprising a resilient hydraulic hose in leak-free assembly with the first end.

8. A coupling assembly comprising:
a flexible tube defining a central channel for fluid communication therethrough;
a second tube axially spaced from the flexible tube where the second tube defines a central channel for fluid communication therethrough; and
a coupling body operatively connected with the flexible tube and the second tube, the coupling body providing a first path of fluid communication adjacent to the flexible tube where the first path includes a first diameter less than an inner diameter of the flexible tube, and a second path of fluid communication adjacent to the second tube where the second path has a second diameter greater than the inner diameter of the flexible tube, where the second path of fluid communication adjacent to the second tube has a length equaling at least half of the length of the coupling body.

9. The coupling assembly as set forth in claim 8, further comprising an annular seal mechanically engaging the second tube and providing a fluid barrier between the second tube and the coupling body when the second tube is at least partially length-wise inserted into the second path.

10. The coupling assembly as set forth in claim 8, further comprising a ring radially extending between the second tube and the coupling body limiting relative axial movement of the second tube and the coupling body.

11. A rigid fluid connector comprising:
a rigid body providing an internal path of fluid communication between a first end and an second end, the first end configured for mating assembly with first external piping comprising rigid conduit having an outside diameter, the second end configured for mating assembly with second external piping, where high-pressure fluid provided to the connector from one of the first and second external piping pass through the internal path to the other of the first and second external piping; and
a first cylindrical bore disposed within the rigid body at the first end, where the first cylindrical bore is adapted to closely receive the rigid conduit to a variable depth within the first cylindrical bore ranging from 1.5 to 3.0 times the outside diameter.

12. The rigid fluid connector as set forth in claim 11, further comprising:
a second cylindrical bore disposed within the rigid body at the second end, where the second cylindrical bore is adapted to closely receive the second external piping comprising rigid conduit having an outside diameter to a variable depth ranging from 1.5 to 3.0 times the outside diameter.

13. The rigid fluid connector as set forth in claim 11, further comprising:
a second cylindrical bore disposed within the rigid body at the second end, where the second end is adapted for insertion into flexible external piping to a variable depth ranging from 1.5 to 3.0 times the outside diameter, and the second cylindrical bore includes an internal diameter substantially equivalent to that of the flexible external piping prior to placement on the second end.

14. The rigid fluid connector as set forth in claim 11, further comprising:
means for preventing axial separation once external piping and a selected one of the first end and the second end are mated, where the means for preventing are disposed within the rigid fluid connector when engaged.

15. The rigid fluid connector as set forth in claim 11, further comprising:
a seal engagable with one of the first and second ends and external piping to inhibit fluid loss between the external piping and the rigid fluid connector; and
a fitting configured to selectively urge the seal, the external piping and the rigid fluid connector together.
